(19) United States
(12) Patent Application Publication
(10) Pub. No.: US 2025/0307474 A1
(43) Pub. Date: Oct. 2, 2025

(54) OPERATIONS AND MAINTENANCE FILE PROTECTION PROCESSES

(71) Applicant: INNOVATIVE PROCESS TECHNOLOGIES, LLC, Peoria, AZ (US)

(72) Inventors: Holly Marie Forden, Peoria, AZ (US); Christopher Alan Bresciani, Phoenix, AZ (US); Laura Lee Allen, Surprise, AZ (US); Thomas Lloyd Fitzgerald, IV, Phoenix, AZ (US)

(73) Assignee: INNOVATIVE PROCESS TECHNOLOGIES, LLC, Peoria, AZ (US)

(21) Appl. No.: 19/240,706

(22) Filed: Jun. 17, 2025

Related U.S. Application Data
(63) Continuation-in-part of application No. 18/389,052, filed on Nov. 13, 2023, now Pat. No. 12,367,181.

(51) Int. Cl. G06F 21/64

(52) U.S. Cl. CPC G06F 21/64

(57) ABSTRACT

Operations and Maintenance Design drawing maintenance, As-Built drawing conformance, and Record Drawing Conformance processes for protecting the integrity of dynamically modified files for Assets through all phases of a drawing's lifecycle.

### RELATED APPLICATIONS

This application claims the benefit of priority under 35 U.S.C. § 120 of pending U.S. patent application Ser. No. 18/389,052 filed Nov. 13, 2023, and is related to U.S. Patent Application No. 62/532,703 filed Jul. 14, 2017, U.S. Patent Application No. 62/645,084 filed Mar. 19, 2018, U.S. patent application Ser. No. 16/036,898 filed Jul. 16, 2018, now issued as U.S. Pat. No. 11,288,228, and U.S. patent application Ser. No. 17/530,531 filed Nov. 19, 2021, now issued as U.S. Pat. No. 11,816,071, the contents of which are incorporated herein by reference in their entireties

### FIELD AND BACKGROUND OF THE INVENTION

The present invention, in some embodiments thereof, relates to information technology and, more particularly, but not exclusively, to enhancement and optimization of tasks using information technology.

### SUMMARY OF THE INVENTION

There is provided in accordance with an aspect of the invention, an operations and maintenance enhanced design drawing conformance process for protecting the integrity of dynamically modified files (Assets), comprising: downloading or copying a Record Drawing File (2D, 3D model or Digital Twin file) from a Remote Database, Document Management System (DMS), Cloud Computing Service (CCS), or File Repository; conforming the Record Drawing File (2D, 3D model or Digital Twin file) for CADD standards for proper model space and paper space usage; reindexing the conformed Record Drawing File (2D, 3D model or Digital Twin file) into the Remote Database, DMS, CCS, or File Repository; renaming the conformed downloaded or copied Record Drawing File (2D, 3D model or Digital Twin file) matching the Record Drawing File Name and with a Unique Project Identifier suffix to distinguish that this file is for project specific design and demolition purposes, known in composition as the Combined new Demolition Construction Sheet File and new Design Construction Sheet File, separating the representation of the new Demolition Construction Sheet File and the new Design Construction Sheet File by individual Paper Space Layouts, which allows a user to discern that removal and addition edits to an existing Record Drawing File (2D, 3D model or Digital Twin file) is required and which also prevents overwrite of data by concurrent changes occurring to the same Record Drawing File (2D, 3D model or Digital Twin file); creating a Layer or Layers categorized as Demolition that includes demolition objects to be removed in the Combined new Demolition Construction Sheet File and new Design Construction Sheet File; creating Layer or Layers categorized as Correctives (with a subcategory for existing conditions that do not exist in the field) that includes existing conditions that require drawing correctives for content or location in the Combined new Demolition Construction Sheet File and new Design Construction Sheet File; creating Layer or Layers categorized as Design; changing demolition objects to the categorized Demolition Layer or Layers within the Combined new Demolition Construction Sheet File and new Design Construction Sheet File; renaming the existing Paper Space Layout to represent the new Demolition Construction Sheet File; creating a new Design Construction Sheet File Paper Space Layout by copying the Paper Space Layout of the new Demolition Construction Sheet File within the Combined new Demolition Construction Sheet File and new Design Construction Sheet File; and naming the copied Paper Space Layout to represent the new Design Construction Sheet File. Freezing the Layer or Layers categorized for Demolition and all Layer or Layers categorized for Correctives within the new Design Construction Sheet File Paper Space Layout Viewport(s) to remove their visibility within the new Design Construction Sheet File. Freezing the Layer or Layers categorized for Design and Layer or Layers categorized for Correctives that are using the Subcategory for existing conditions that do not exist in the field within the new Demolition Construction Sheet File Paper Space Layout Viewport(s) to remove their visibility within the new Demolition Construction Sheet File and saving the file. This file will be plotted and distributed for construction activities.

In an embodiment of the invention, downloading is from a Remote Database, DMS, CCS, or File Repository.

In an embodiment of the invention, conforming includes validating and applying Layer standards, validating Borders as externally referenced entities (XREF), inserting Border Informational Text into a Paper Space Layout to allow for variable information to be managed and maintained, allowing for mapped values (metadata) into the Remote Database, DMS, CCS, or File Repository, and moving historical text, dimensions and notes found in paper space into model space to their correct spatial locations and applying an appropriate scale factor to this information to ensure legibility and that all historical data can be correctly used within the process.

In an embodiment of the invention, conforming includes re-indexing the conformed Record Drawing File (2D, 3D model or Digital Twin file) into the Remote Database, DMS or CCS, or File Repository prior to the creation of the single file representation of the Combined new Demolition Construction Sheet File and new Design Construction Sheet File to ensure that all drawing historical data, now in model space, is saved, available and can be correctly used within the process.

In an embodiment of the invention, renaming matching the Record Drawing File Name and with a Unique Project Identifier suffix to distinguish that this document is for project specific demolition and design purposes, known as the Combined new Demolition Construction Sheet File and new Design Construction Sheet File which allows a user to discern that removal and addition edits to an existing Record Drawing File (2D, 3D model or Digital Twin file) is required, while also preventing overwrite of data by concurrent changes occurring to other copies of the same Record Drawing File (2D, 3D model or Digital Twin file) by other files with another Unique Project Identifier Numbers suffix.

In an embodiment of the invention, the process further comprises saving the file representing the Combined new Demolition Construction Sheet File and new Design Construction Sheet File in a separate directory designated for Project Files used for file compositions in the Combined new Demolition Construction Sheet File and new Design Construction Sheet File.

In an embodiment of the invention, the process further comprises making sure that the origins of both the Record Drawing File (2D, 3D model or Digital Twin file) and the Combined new Demolition Construction Sheet File and the new Design Construction Sheet File are in the same spatial location.

In an embodiment of the invention, creating the Combined New Demolition Construction Sheet File and New Design Construction Sheet File further comprises freezing within the new Design Construction Sheet File Paper Space Layout Viewport(s) the Demolition Layer and all Correctives Layer to remove their visibility within the new Design Construction Sheet File.

In an embodiment of the invention, creating the Combined New Demolition Construction Sheet File and New Design Construction Sheet File further comprises freezing the Correctives Layer or Layers that are using a Subcategory for existing conditions within the new Demolition Construction Sheet File Paper Space Layout Viewport(s) that do not exist in the field to remove their visibility within the new Demolition Construction Sheet File.

In an embodiment of the invention, creating the Combined new Demolition Construction Sheet File and new Design Construction Sheet File further comprises placing all new items to be added during the construction project on the appropriate Layer or Layers that are designated for Design, wherein all layer names used in the Record Drawing File (2D, 3D model or Digital Twin file), Combined new Demolition Construction Sheet File and new Design Construction Sheet File should be exactly the same in naming convention with a category designation that represents Demolition, Correctives, Correctives with a subcategory designating that there are existing conditions that do not exist in the field and Design with the entity properties set to ByLayer.

In an embodiment of the invention, the process further comprises creating a Layer or Layers categorized as Demolition, Correctives, Correctives with a subcategory designating that there are existing conditions that do not exist in the field and Design with the entity properties set to ByLayer in the Combined new Demolition Construction Sheet File and new Design Construction Sheet File.

In an embodiment of the invention, the process further comprises correcting items in the Combined new Demolition Construction Sheet File and new Design Construction Sheet File and copying the items while moving them to a desired spatial location and changing the copied items to an appropriate Layer or Layers designated as Design then changing the color of the copied items to grayscale.

In an embodiment of the invention, the process further comprises correcting items in the Combined new Demolition Construction Sheet File and new Design Construction Sheet File and changing the items to the appropriate Layer or Layers designated as Correctives for objects to be moved.

In an embodiment of the invention, the process further comprises correcting items in the Combined new Demolition Construction Sheet File and new Design Construction Sheet File and changing the items to the appropriate Layer or Layers designated as Correctives with a subcategory for objects that do not exist in the field.

In an embodiment of the invention, the process further comprises deleting items in the Combined new Demolition Construction Sheet File and new Design Construction Sheet File.

In an embodiment of the invention, creating the Combined new Demolition Construction Sheet File and new Design Construction Sheet File includes freezing the Correctives with Subcategory designation layers within the new Demolition Construction Sheet File Paper Space Layout Viewport(s) to remove their visibility if it is being used to remove an existing condition that does not exist in the field and placing notes and call out leaders on the appropriate layers in paper space.

In an embodiment of the invention, creating the Combined new Demolition Construction Sheet File and new Design Construction Sheet File includes freezing the Layer or Layers designated for Demolition and all Layer or Layers designated for Correctives within the new Design Construction Sheet File Paper Space Layout Viewport(s) to remove their visibility.

In an embodiment of the invention, creating the new Design Construction Sheet File copying the new Demolition Construction Sheet File Paper Space Layout and renaming it to represent the new Design Construction Sheet File, placing notes and call out leaders on the appropriate layers in paper space, as these notes relate to construction activities only and will not be retained as historical information for incorporation into the Record Drawing File (2D, 3D model or Digital Twin file).

In an embodiment of the invention, colors are used to differentiate at least one of the layers, files, and operations to be performed.

There is further provided in accordance with an aspect of the invention, an operations and maintenance Record Drawing Conformance Process for conforming Construction Drawings prior to release for Construction, and protecting the integrity of dynamically modified files, comprising: downloading or copying a Record Drawing File (2D, 3D model or Digital Twin file) from Remote Database, DMS, CCS, or File Repository to a working location; deleting all layers in model space of the Combined new Demolition Construction Sheet File and new Design Construction Sheet File with exception of the Layer or Layers designated for Demolition, Correctives, Correctives with subcategory and Design and with the use of Artificial Intelligence and Machine Learning or Database Comparison Tools to perform spatial analysis of the Record Drawing File (2D, 3D model or Digital Twin file) to import all layers found in model space into the Combined new Demolition Construction Sheet File and new Design Construction Sheet File. Using Artificial Intelligence and Machine Learning or Database Comparison Tools to spatially locate and validate duplicated items that will be deleted, comparing between the imported content of the Record Drawing File and the Layer or Layers designated for Demolition, Correctives and Correctives with subcategory within the Combined new Demolition Construction Sheet File and new Design Construction Sheet File, then removing these duplicated items that were imported from the Record Drawing File within the Combined new Demolition Construction Sheet File and new Design Construction Sheet File while retaining all objects found on the Layer or Layers designated for Demolition, Correctives, Correctives with subcategory and Design within the Combined new Demolition Construction Sheet File and new Design Construction Sheet File.

In an embodiment of the invention, the process further comprises: conforming the Combined new Demolition Construction Sheet File and new Design Construction Sheet File for As-built including making revisions to the new Demolition Construction Sheet File in both model space and paper space for any field revisions that occurred during construction activities; downloading or copying a Record Drawing File (2D, 3D model or Digital Twin file) from a Remote Database, DMS, CCS, or File Repository to a working location; deleting all layers in model space of the Combined new Demolition Construction Sheet File and new Design Construction Sheet File with exception of the Layer or Layers designated for Demolition, Correctives, Correctives with subcategory and Design and performing spatial analysis of the Record Drawing File (2D, 3D model or Digital Twin file) with the use of Artificial Intelligence and Machine Learning or Database Comparison Tools to import all layers found in the model space of the Record Drawing File into the model space of the Combined new Demolition Construction Sheet File and new Design Construction Sheet File; Using Artificial Intelligence and Machine Learning or Database Comparison Tools to spatially locate and validate duplicated items that will be deleted, comparing between the imported content of the Record Drawing File and the Layer or Layers designated for Demolition, Correctives and Correctives with subcategory of the Combined new Demolition Construction Sheet File and new Design Construction Sheet File, then removing these duplicated items that were imported from the Record Drawing File within the Combined new Demolition Construction Sheet File and new Design Construction Sheet File while retaining all objects found on the Layer or Layers designated for Demolition, Corrective and Design within the Combined new Demolition Construction Sheet File and new Design Construction Sheet File; conforming the Combined new Demolition Construction Sheet File and new Design Construction Sheet File for As-built including making revisions to the new Demolition Construction Sheet File and new Design Construction Sheet File in both model space and paper space, if necessary, for any field revisions that occurred during construction activities; updating the Revision Block in the new Demolition Construction Sheet File Paper Space Layout and updating the Revision Block in the new Design Construction Sheet File Paper Space Layout; and, routing conformed As-Built drawings, comprising the Combined new Demolition Construction Sheet File and new Design Construction Sheet File, for approval to apply the changes to the latest historical Record Drawing File (2D, 3D model or Digital Twin file).

There is further provided in accordance with an aspect of the invention, an operations and maintenance Record Drawing Conformance Process for protecting the integrity of dynamically modified files (2D, 3D model or Digital Twin file) Assets, comprising: downloading or copying a Record Drawing File (2D, 3D model or Digital Twin file) from a Remote Database, DMS, CCS, CADD Software, or File Repository to a working location; Comparing the Layer or Layers designated for Demolition and the Layer or Layers designated for Correctives and Correctives with subcategory from the Combined new Demolition Construction Sheet File and new Design Construction Sheet File with the use of Artificial Intelligence and Machine Learning or Database Comparison Tools to perform spatial analysis to identify and delete duplicated geometries, dimensions and text from the Record Drawing File (2D, 3D model or Digital Twin file) objects that appear on Layer or Layers designated for Demolition and the Layer or Layers designated for Correctives and Correctives with subcategory from the Combined new Demolition Construction Sheet File and new Design Construction Sheet File; Using Artificial Intelligence and Machine Learning or Database Comparison Tools to perform spatial analysis, to query the Combined new Demolition Construction Sheet File and new Design Construction Sheet File to import all Layer or Layers designated for Design found in model space into the Record Drawing File (2D, 3D model or Digital Twin file) merging all Layer or Layers designated for Design to the corresponding existing conditions layer, adjusting all entity colors to ByLayer upon import; and, plotting Record Drawing File and routing the plotted Updated Record Drawing File (2D, 3D model or Digital Twin file) for approval prior to indexing the Record Drawing File (updated next historical release of a 2D, 3D model or Digital Twin file) into the Remote Database, DMS, CCS, CADD Software, or File Repository.

Unless otherwise defined, all technical and/or scientific terms used herein have the same meaning as commonly understood by one of ordinary skill in the art to which the invention pertains. Although methods and materials similar or equivalent to those described herein can be used in the practice or testing of embodiments of the invention, exemplary methods and/or materials are described below. In case of conflict, the patent specification, including definitions, will control. In addition, the materials, methods, and examples are illustrative only and are not intended to be necessarily limiting. Implementation of the method and/or system can involve performing or completing selected tasks manually, automatically, or a combination thereof. Moreover, according to actual instrumentation and equipment of embodiments of the method and/or system of the invention, several selected tasks could be implemented by hardware, by software or by firmware or by a combination thereof using an operating system.

For example, hardware for performing selected tasks according to embodiments of the invention could be implemented as a chip or a circuit. As software, selected tasks according to embodiments of the invention could be implemented as a plurality of software instructions being executed by a computer using any suitable operating system. In an exemplary embodiment of the invention, one or more tasks according to exemplary embodiments of method and/or system as described herein are performed by a data processor, such as a computing platform for executing a plurality of instructions. Optionally, the data processor includes a volatile memory for storing instructions and/or data and/or a non-volatile storage, for example, a magnetic hard-disk and/or removable media, for storing instructions and/or data. Optionally, a network connection is provided. A display and/or a user input device such as a keyboard or mouse are optionally provided.

### BRIEF DESCRIPTION OF THE SEVERAL VIEWS OF THE DRAWING(S)

Some embodiments of the invention are herein described, by way of example only, with reference to the accompanying drawings and images. With specific reference now to the drawings and images in detail, it is stressed that the particulars shown are by way of example, are not necessarily to scale, and are for purposes of illustrative discussion of embodiments of the invention. In this regard, the description taken with the drawings makes apparent to those skilled in the art how embodiments of the invention may be practiced.

In the drawings:

FIG. 1-2 is a flowchart showing an exemplary Operations and Maintenance Design Drawing Conformance Process, in an aspect;

FIGS. 3-15 show exemplary and/or alternative actions performable with an Operations and Maintenance Design Drawing Conformance Process, in an aspect;

FIG. 16 is a flowchart showing an exemplary Operations and Maintenance As-Built Drawing Conformance Process, in an aspect;

FIGS. 17-19 show exemplary actions performable with an Operations and Maintenance As-Built Drawing Conformance Process, in an aspect;

FIG. 20 is a flowchart showing an exemplary Operations and Maintenance Record Drawing Conformance Process, in an aspect;

FIGS. 21-23 show exemplary actions performable with an Operations and Maintenance Record Drawing Conformance Process, in an aspect;

### DESCRIPTION OF SPECIFIC EMBODIMENTS OF THE INVENTION

The present invention, in some embodiments thereof, relates to information technology and, more particularly, but not exclusively, to enhancement and optimization of tasks using information technology.

Before explaining at least one embodiment of the invention in detail, it is to be understood that the invention is not necessarily limited in its application to the details of construction and the arrangement of the components and/or methods set forth in the following description and/or illustrated in the drawings. The invention is capable of other embodiments or of being practiced or carried out in various ways.

Generally, without competent drawing content management policies and procedures in place, operations, assets, and risk management, which require exceptional management and operational focus to succeed, become even more daunting challenges, most especially in the utility and facility management industries worldwide.

Utility and facility organizations are often faced with the challenge of working with dynamically changing computer aided drafting and design (CADD) files during the DESIGN, AS-BUILT and RECORD CONFORMANCE process of Operations and Maintenance (“O&M”) utility or facilities upgrades of Assets. Complicating the issue further, it is not unreasonable for this problem to be exacerbated by multiple concurrent Designs, As-Builts or Record drawing updates utilizing the same Record Drawing File (2D, 3D model or Digital Twin file) of Assets. It should be understood that the processes described herein are intended to enable utility and facility maintenance industries worldwide to efficiently and effectively manage and maintain these dynamically changing O&M record drawings of Assets. For example, the processes described herein reduce and/or eliminate the possible loss and/or overwrite of data that may occur while trying to update and maintain dynamically changing Record Drawing Files (2D, 3D model or Digital Twin file) of Assets.

While the following process examples utilize Autodesk® software, it can be incorporated for use in any commercially available Remote Database, DMS, CCS, File Repository or CADD Software application currently, or in the future, that use Artificial Intelligence and Machine Learning or Database Comparison Tools for sale in the engineering industry.

The following defined terms are used throughout this description:

As-Built: A term used to describe the approved final construction conditions of a project.

Block: Multiple CADD drawing entities combined into one group.

Conformed Record Drawing File: a copy and renamed Record Drawing File (2D, 3D model or Digital Twin file) of Assets that has been conformed to meet proper layering standards, organizational CADD standards, and model space and paper space usage. In essence, it is a “snapshot in time” used to convey existing conditions, demolition and correctives that occur during the design and construction phases of a project.

Conforming: To update a file with the latest information.

COPYBASE: A CADD command to copy objects from a known base point coordinate determined by the Editor. For example, 0,0.

Demolition Construction Sheet File: CADD drawing file Construction Contract

Document used to show demolition items.

Design File: CADD drawing file that reflects a new design.

Design Construction Sheet File: CADD drawing file Construction Contract Document used to show new design items.

Combined new Demolition Construction Sheet File and new Design Construction Sheet File: A single CADD file that contains two Paper Space Layouts that represent the Demolition Construction Sheet file and the Design Construction Sheet file respectively.

Paper Space Layout: a 2D working environment for creating drawing sheets.

Paper Space Layout Viewport(s): Layout viewports are objects that display views of model space.

Externally Referencing: A method of file composition where one CADD drawing file is designated to be overlaid (externally referenced) into another CADD drawing file. Paper space items in the XREF files are ignored and model space items are viewable/printable.

Record Drawing File: A recorded CADD drawing file document of an Asset, whether an existing 2D, 3D model or Digital Twin file, that retains historical information for every approved As-Built Revision change that has occurred since its first record drawing release.

Revision Block: A textual annotation block that is updated with every release of a document describing the Reason for Document Change, Revision Letter or Number and date of Approval for Official Release.

XREF: A designation for a file that will be used for externally referencing one CADD drawing file into another CADD drawing file. For example, the border will be externally referenced into the Record Drawing File Paper Space Layout.

Artificial Intelligence: The general ability of a computer to emulate human thought and perform complex tasks, such as analyzing, in real-world environments.

Machine Learning: A subset of Artificial Intelligence that uses technologies and algorithms that enables systems to identify patterns, make decisions, and improve themselves through experience and data.

Asset: An existing facility system or component thereof that will be maintained, modified, expanded, redeveloped, reused or replaced.

Spatial Analysis: The process of examining, assessing, evaluating, and comparing spatial data features such as locations, attributes, and relationships that reveal the geometric or geographic properties of data.

Digital Twin File: A virtual 3D model or 2D CADD drawing of a real-world physical product, system or process that serves as the effectively indistinguishable digital counterpart of it for practical purposes, such as simulation, integration, testing, monitoring, and maintenance.

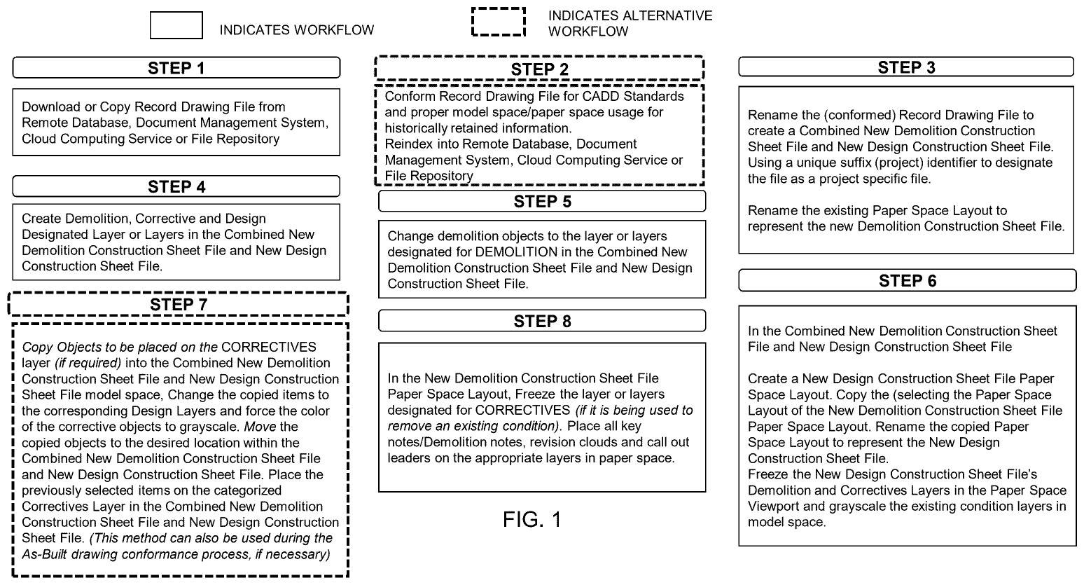

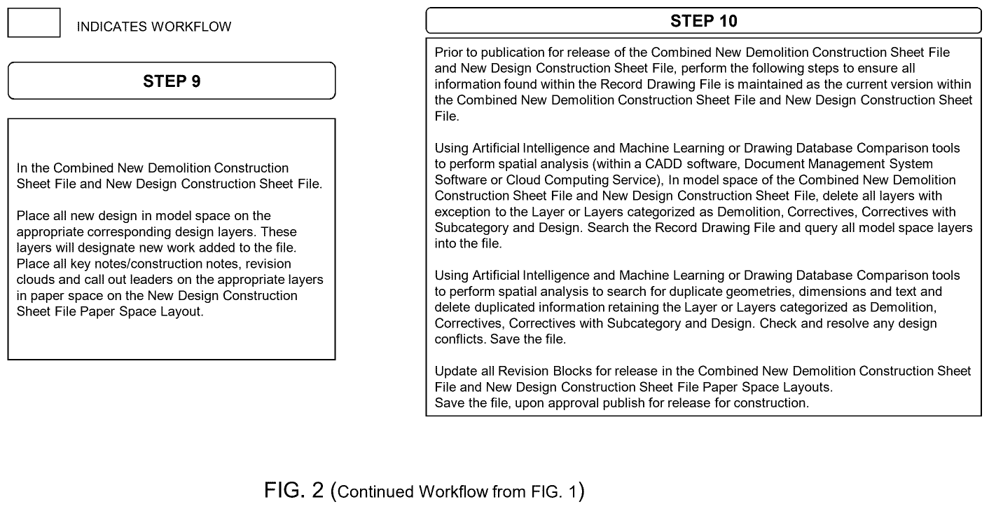

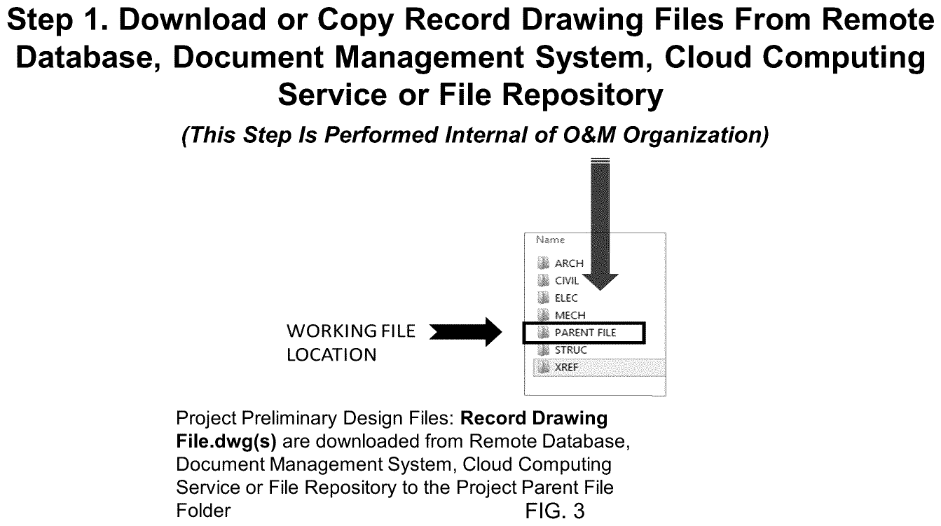

Referring now to the drawings, FIGS. 1 and 2 is a schematic flowchart showing an exemplary O&M Design Drawing Conformance Process for protecting the integrity of dynamically modified files of Assets, in an aspect. Exemplary actions taken are described in more detail with respect to FIGS. 3-12, below.

FIG. 3 shows a detailed screenshot view of performing a Step 1—Download or copy the Record Drawing File (2D, 3D model or Digital Twin file) of an Asset from Remote Database. DMS, CCS or File Repository (if applicable).

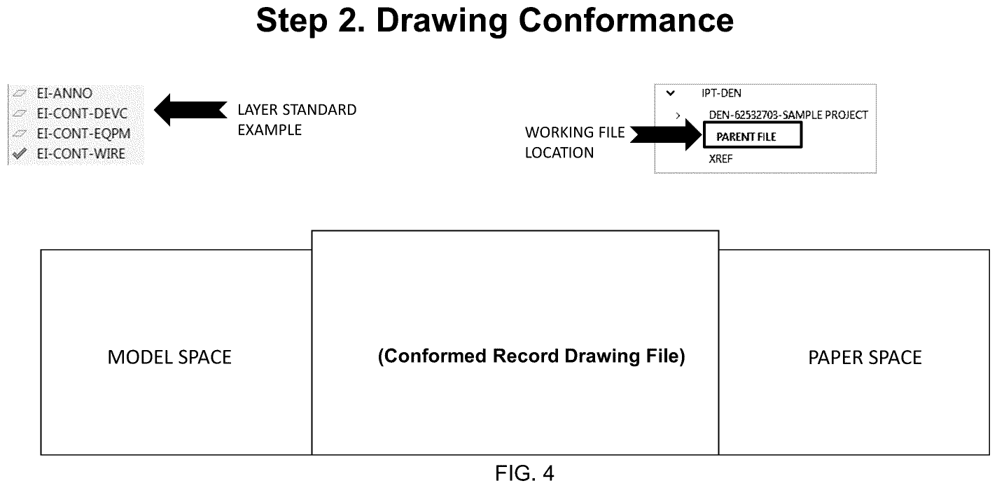

FIG. 4 shows a detailed screenshot view of performing a Step 2—Conformance of the Record Drawing File (2D, 3D model or Digital Twin file) of an Asset will consist of converting recorded historical information potentially located in paper space that will be displayed throughout the Design process to model space. Layer standards will also be validated and applied. Borders will be validated as externally referenced entities (non-Variable linework for the O&M Organization) and Border Informational Text will be inserted into the Paper Space Layout to allow for Variable information to be managed and maintained (allowing for mapped values as metadata into a Remote Database, DMS, CCS, or File Repository). This completed conformed drawing should be immediately re-indexed into the Remote Database, DMS, CCS, or File Repository if this step is required of the file.

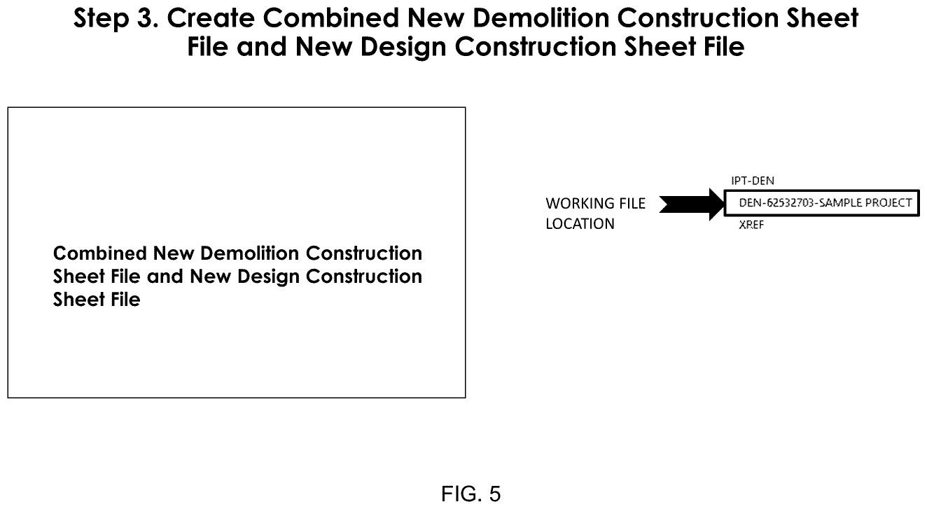

FIG. 5 shows a detailed screenshot view of performing a Step 3—Rename the completed conformed Record Drawing File (2D, 3D model or Digital Twin file) of an Asset to create a Combined new Demolition Construction Sheet File and new Design Construction Sheet File. Using a unique suffix (project) identifier to designate the file as a project file. This Unique Identifier will allow the organization to discern that an edit (items to be removed and added) to an existing Record Drawing File (2D, 3D model or Digital Twin file) of an Asset will be required in the O&M Record Drawing File Conformance Process and also prevent overwrite of data by concurrent changes occurring to the same Record Drawing File (2D, 3D model or Digital Twin file) of an Asset. This new file will be referred to as the Combined new Demolition Construction Sheet File and new Design Construction Sheet File in some embodiments of this process. Save this file in a separate directory designated for Project Files used for file compositions in the Demolition and Design Construction Sheet Files.

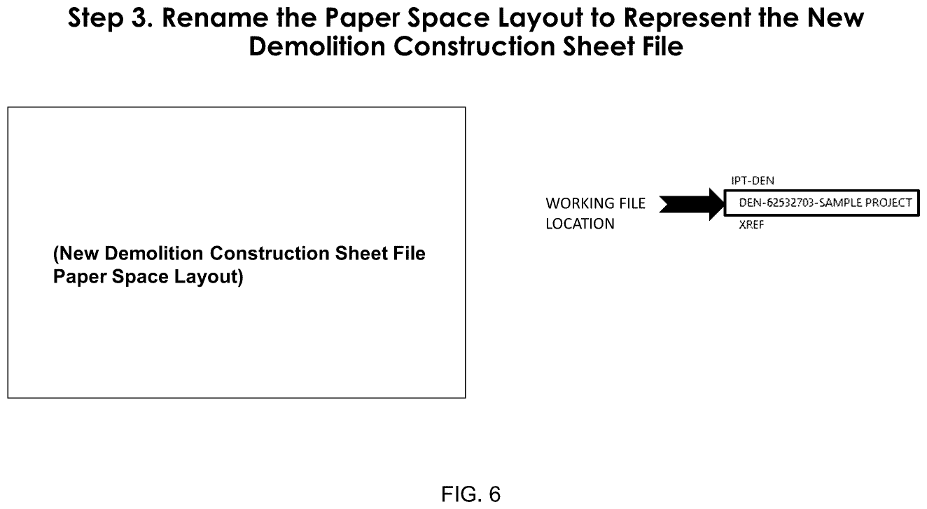

FIG. 6 Renaming Paper Space Layout to represent the New Demolition Construction Sheet File which allows a user to discern that removal edits in the O&M Record Drawing File Conformance Process are required and also prevent overwrite of data by concurrent changes occurring to the same Record Drawing File (2D, 3D model or Digital Twin File).

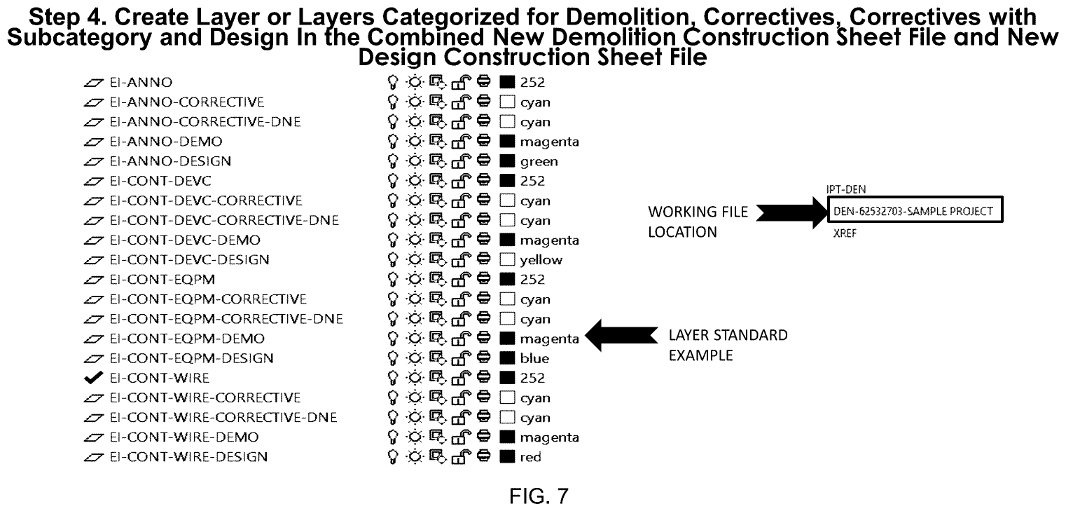

FIG. 7 Shows a detailed screenshot view of performing a Step 4—Create a Layer or Layers designated for (DEMOLITION) that will represent the demolition or items to be removed during construction activities in the Combined new Demolition Construction Sheet File and new Design Construction Sheet File and set to a color that will be specific for items to be removed. Create a Layer or Layers designated for (CORRECTIVES) with a subcategory for existing conditions that do not exist in the field (if required) that will represent existing conditions that require drawing correctives for content or location in the Combined new Demolition Construction Sheet File and new Design Construction Sheet File and set to a color that will be specific for items to be relocated or corrected. This layer may need to be used when moving or making correctives to existing condition items in the new Design Construction Sheet File as described in Alternative Workflow for Moving or Deleting Existing Items beginning at Step 7 (if required). Create a Layer or Layers designated for (DESIGN) that will represent design items added in the Combined new Demolition Construction Sheet File and new Design Construction Sheet File and set to a color that will be specific for items added during construction activities (New Work).

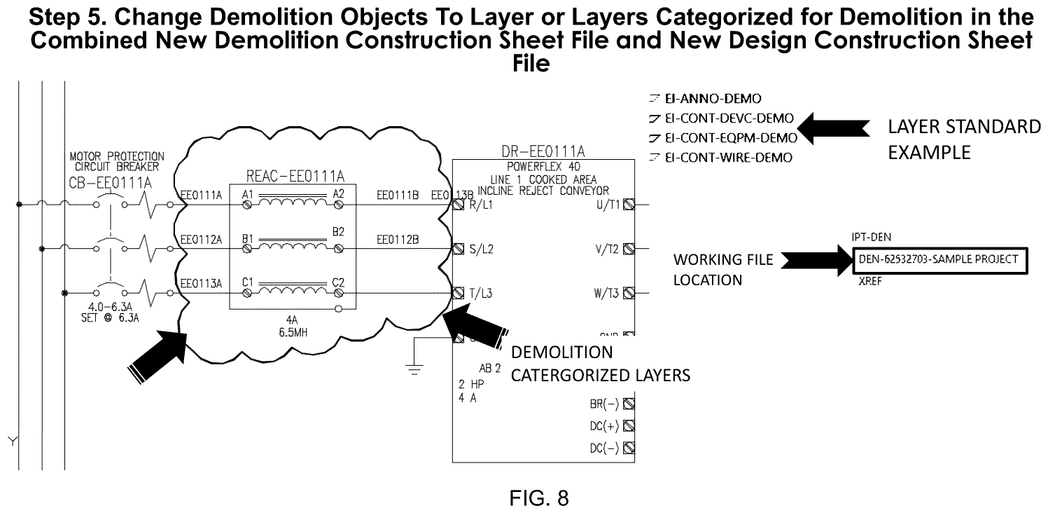

FIG. 8 shows a detailed screenshot view of performing a Step 5—Change demolition objects to the Layer or Layers designated for DEMOLITION within the Combined new Demolition Construction Sheet File and new Design Construction Sheet File. The demolition objects are the items to be removed during the construction of the new design.

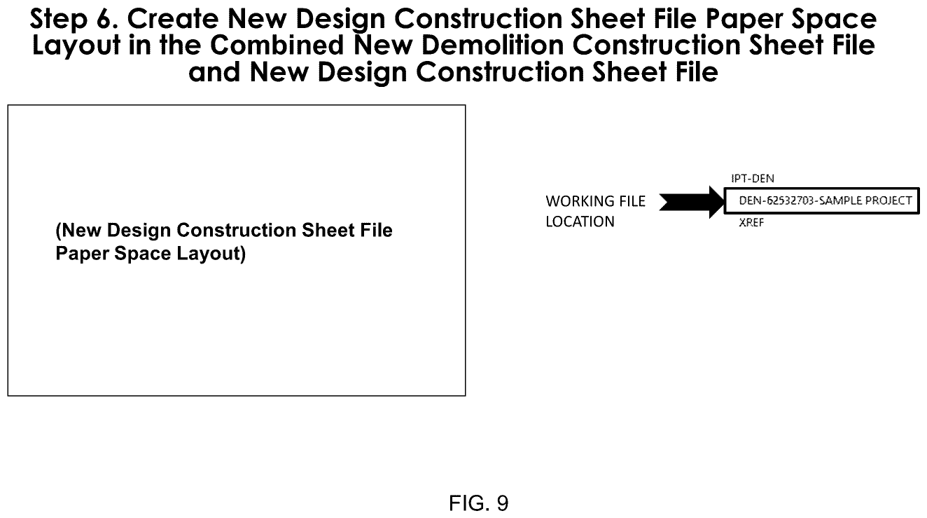

FIG. 9 shows a detailed screenshot view of performing a Step 6—creating a new Design Construction Sheet File Paper Space Layout by copying the new Demolition Construction Sheet File Paper Space Layout of the Combined new Demolition Construction Sheet File and new Design Construction Sheet File and rename the copied Paper Space Layout to represent the new Design Construction Sheet File which allows a user to discern that addition edits in the O&M Record Drawing File Conformance Process are required and also prevent overwrite of data by concurrent changes occurring to the same Record Drawing File (2D, 3D model or Digital Twin File). FREEZE the Layer or Layers designated for DEMOLITION, CORRECTIVES and CORRECTIVES with Subcategory within the new Design Construction Sheet File Paper Space Layout Viewport(s). This file's Paper Space Layouts will be plotted and distributed for construction activities.

In an embodiment, this file is saved in a separate directory designated for Project Files used for file compositions in the Combined new Demolition and Design Construction Sheet Files. In an embodiment, all existing condition layers in the Combined new Demolition Construction Sheet File and new Design Construction Sheet File are grayscaled, and all new items to be added during the construction project are placed on the appropriate discipline specific layers. Note: All layer names used in the Record, Combined new Demolition Construction Sheet File and new Design Construction Sheet File should be exactly the same in naming convention with a category designation for Demolition, Correctives, Correctives with subcategory and Design with the entity properties set to by-layer. This removes the need for extensive manual manipulation of data during the Operations and Maintenance (O&M) Record Drawing Conformance Process of the Asset, in an embodiment.

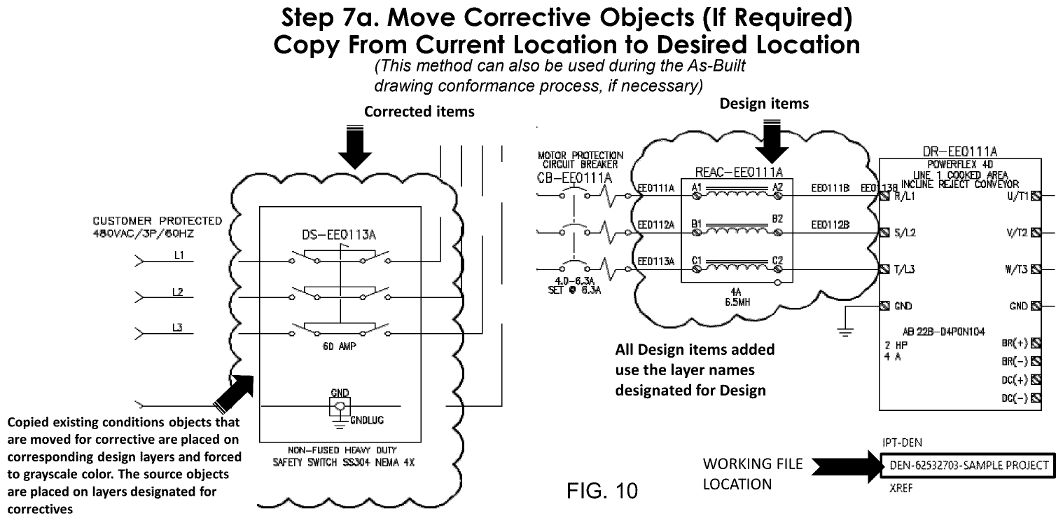

FIG. 10 shows a detailed screenshot view of performing a Step 7a-Alternative Workflow for Correcting Existing Items (if required). Moving Corrective objects by copying existing objects from a selected base point to a desired location and changing the layers of the copied objects to a Layer or Layers designated for DESIGN and forcing the object colors to grayscale. Changing the previously sourced objects used in the copy operation to a corresponding Layer or Layers designated for CORRECTIVES in the Combined new Demolition Construction Sheet File and new Design Construction Sheet File.

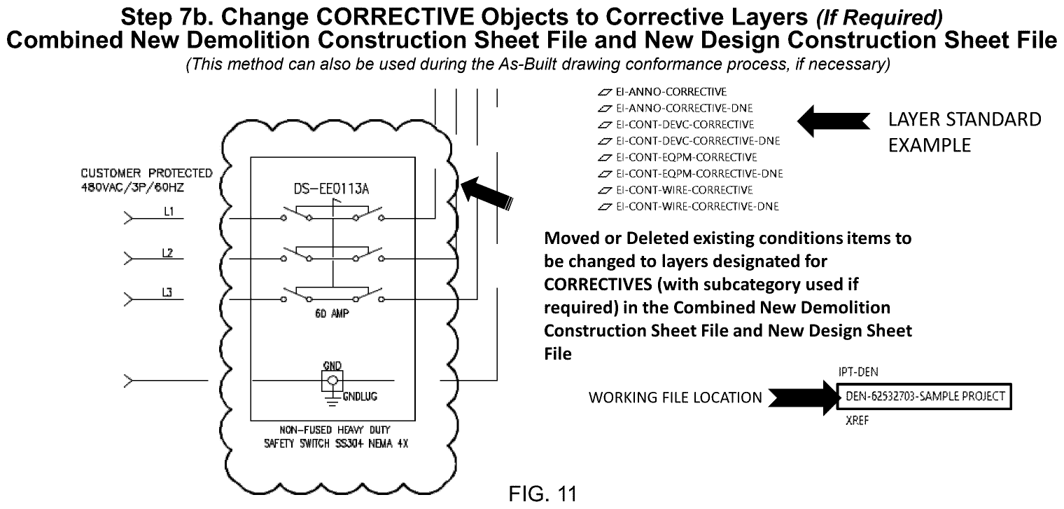

FIG. 11 shows a detailed screenshot view of performing a Step 7b-Alternative Workflow for Moving or Deleting Existing Items (if required). Change Objects from the Combined new Demolition Construction Sheet File and new Design Construction Sheet File that have been selected to meet the following criteria; (Objects do not exist in the field, or objects are being corrected in the file to show current location in the field), to the Layer or Layers designated for CORRECTIVES (using the subcategory if necessary). It should be noted that the Layer or Layers designated for CORRECTIVES will be ON in the new Demolition Construction Sheet File Paper Space Layout and (see Step 8) unless the Layer or Layers designated for CORRECTIVES will be used for removal of existing conditions that do not exist in the field (subcategory). If this is the case, then the Layer or Layers designated for CORRECTIVES with subcategory will be FROZEN in the new Demolition Construction Sheet File Paper Space Layout (see Step 8). The CORRECTIVES Layers and Corrective Layers with subcategory in the Combined new Demolition Construction Sheet File and new Design Construction Sheet File will also be FROZEN in the new Design Construction Sheet File Paper Space Layout (see Step 9).

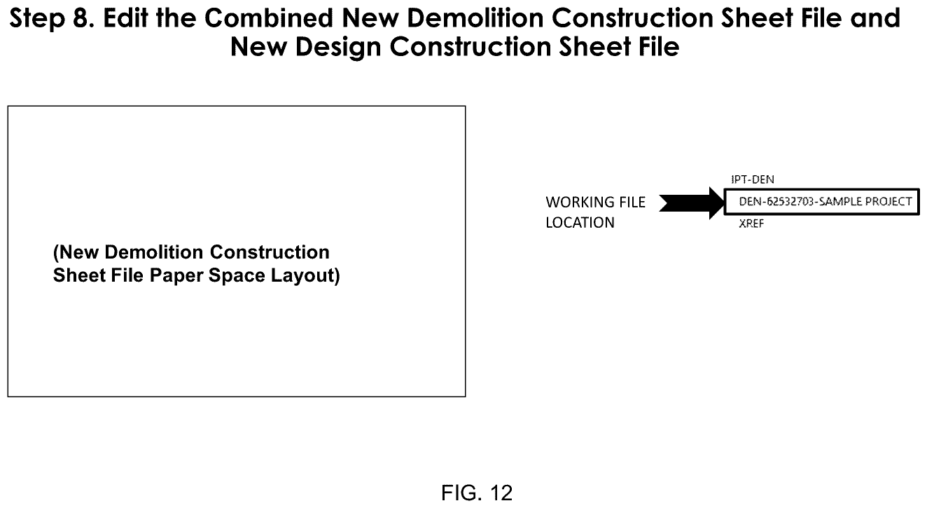

FIG. 12 shows a detailed screenshot view of performing a Step 8—In the new Demolition Construction Sheet File Paper Space Layout, grayscale all Existing Condition Layers except the DEMOLITION Layer and FREEZE the DESIGN Layers and the CORRECTIVES Layers with Subcategory (if it is being used to remove an existing condition). Place all key notes/demolition notes, revision clouds and call out leaders on the appropriate layers in paper space.

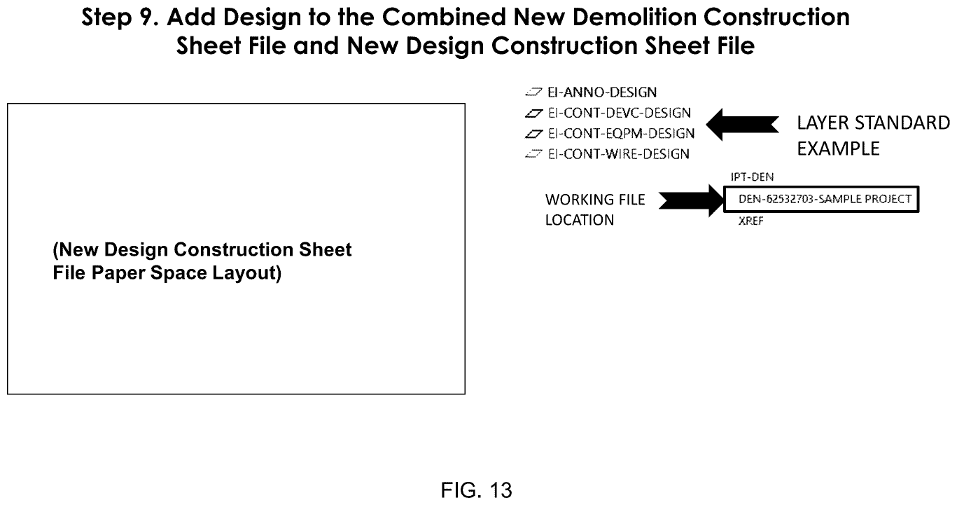

FIG. 13 shows a detailed screenshot view of performing a Step 9—In the new Design Construction Sheet File Paper Space Layout grayscale all the existing condition layers found in the Combined new Demolition Construction sheet File and new Design Construction Sheet File that is found in model space, Place all new design on the appropriate corresponding designated Design Layers that match correspond with the layer names of the existing conditions. These layers will designate new work added to the file. Place all key notes/construction notes, revision clouds and call out leaders on the appropriate layers in paper space.

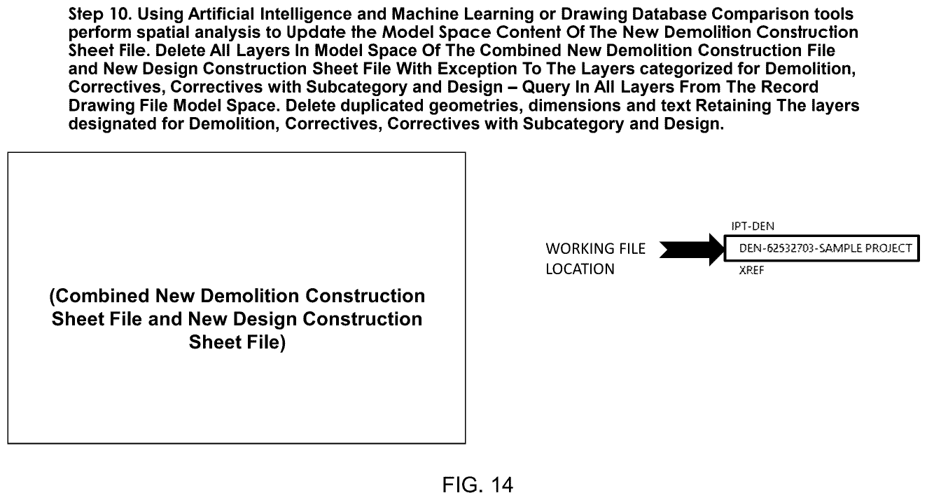

FIG. 14 shows a detailed screenshot view of performing a Step 10—Prior to publication for release of the Combined new Demolition Construction Sheet File and the new Design Construction Sheet File, perform the following steps to ensure all information found within the Record Drawing File (2D, 3D model or Digital Twin file) is maintained as the current version within the Combined new Demolition Construction Sheet File and new Design Construction Sheet File. Update all Revision Blocks for release. downloading or copying a Record Drawing File (2D, 3D model or Digital Twin file) from Remote Database, DMS, CCS, or File Repository to a working location; deleting all layers in model space of the Combined new Demolition Construction File and new Design Construction Sheet File with exception of the Layer or Layers designated for Demolition, Correctives, Correctives with subcategory and Design and with the use of Artificial Intelligence and Machine Learning or Database Comparison Tools to perform spatial analysis of the Record Drawing File (2D, 3D model or Digital Twin file) to import all layers found in model space into the Combined new Demolition Construction File and new Design Construction Sheet File. Using Artificial Intelligence and Machine Learning or Database Comparison Tools to spatially locate and validate duplicated items that will be deleted, comparing between the imported content of the Record Drawing File and the Layer or Layers designated for Demolition and the Layer or Layers designated for Correctives and Correctives with subcategory of the Combined new Demolition Construction File and new Design Construction Sheet File, then removing these duplicated items that were imported from the Record Drawing File within the Combined new Demolition Construction File and new Design Construction Sheet File while retaining all objects found on the Layer or Layers designated for Demolition, Correctives, Correctives with subcategory and Design within the Combined new Demolition Construction File and new Design Construction Sheet File.

Check and resolve any design conflicts. Save the file.

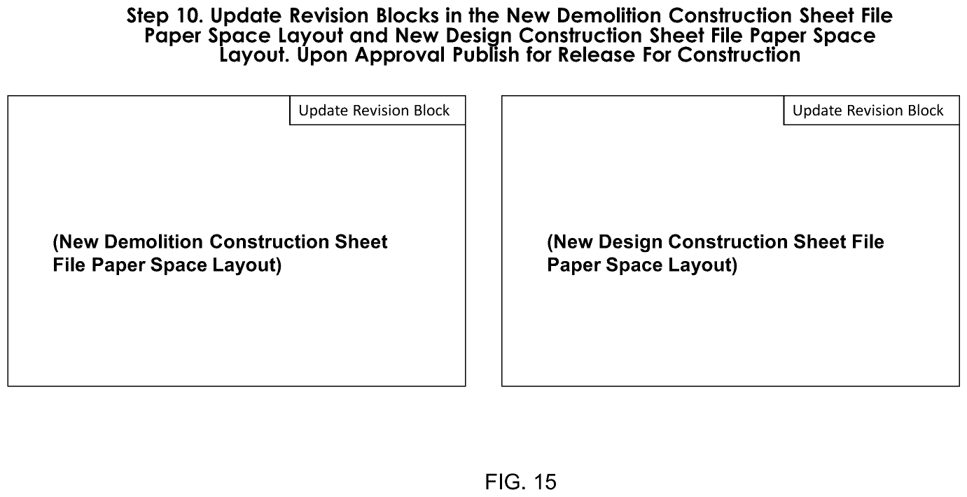

FIG. 15 shows a detailed screenshot view of performing of a Step 10. Update Revision Blocks in new Demolition Construction Sheet File Paper Space Layout and new Design Construction Sheet File Paper Space Layout and save the files. Upon approval, publish both the new Demolition Construction Sheet File Paper Space Layout and the new Design Construction Sheet File Paper Space Layout for release for construction.

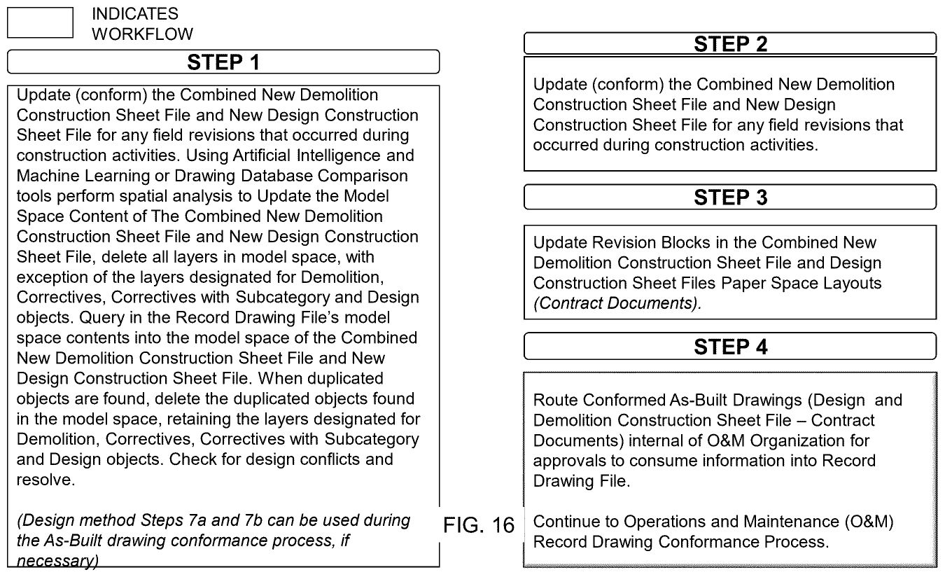

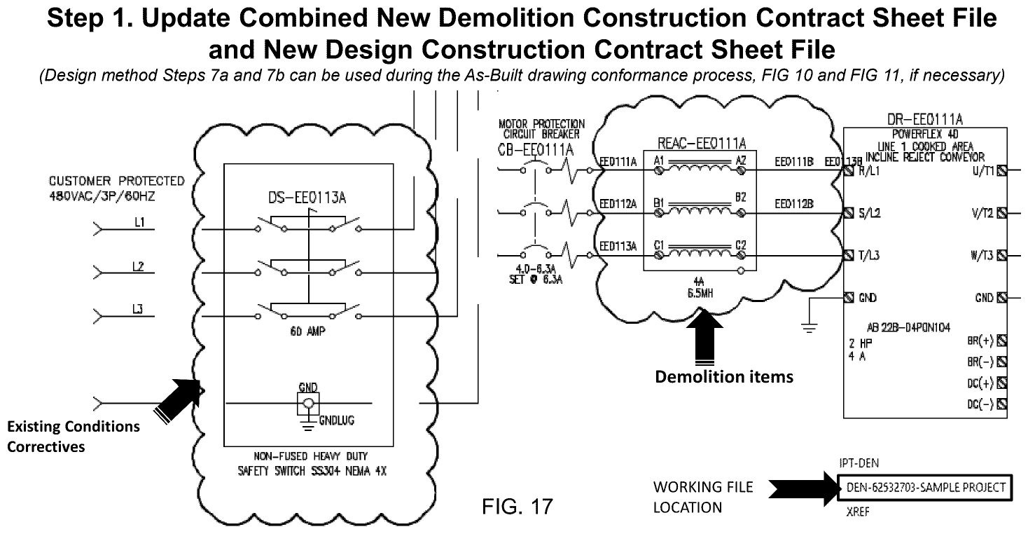

FIG. 16 is a flowchart showing an exemplary O&M As-Built Drawing Conformance Process for protecting the integrity of dynamically modified files, in an aspect. Exemplary actions taken are described in more detail with respect to FIGS. 17-19, below.

FIG. 17 shows a detailed screenshot view of performing a Step 1—Update (conform) the Combined new Demolition Construction File and new Design Construction Sheet File. Make necessary revisions to the Combined new Demolition Construction File and new Design Construction Sheet File if necessary for any field revisions that occurred during construction activities. Perform the following steps to ensure all information found within the Record Drawing File (2D, 3D model or Digital Twin file) is maintained as the current version within the Combined new Demolition Construction File and new Design Construction Sheet File.

Downloading or copying a Record Drawing File (2D, 3D model or Digital Twin file) from a Remote Database, DMS, CCS, or File Repository to a working location; deleting all layers in model space of the Combined new Demolition Construction File and new Design Construction Sheet File with exception of the Layer or Layers designated for Demolition, Correctives, Correctives with subcategory and Design and performing spatial analysis of the Record Drawing File (2D, 3D model or Digital Twin file) with the use of Artificial Intelligence and Machine Learning or Database Comparison Tools to import all layers found in the model space of the Record Drawing File into the model space of the Combined new Demolition Construction File and new Design Construction Sheet File; Using Artificial Intelligence and Machine Learning or Database Comparison Tools to spatially locate and validate duplicated items that will be deleted, comparing between the imported content of the Record Drawing File and the Layer or Layers designated for Demolition, Correctives, Correctives with subcategory of the Combined new Demolition Construction File and new Design Construction Sheet File, then removing these duplicated items that were imported from the Record Drawing File within the Combined new Demolition Construction File and new Design Construction Sheet File while retaining all objects found on the Layer or Layers designated for Demolition, Correctives, Correctives with subcategory and Design within the Combined new Demolition Construction File and new Design Construction Sheet File; conforming the Combined new Demolition Construction File and new Design Construction Sheet File for As-built including making revisions to file in both model space and paper space, if necessary, for any field revisions that occurred during construction activities; updating the Revision Blocks in the new Demolition Construction Sheet File Paper Space Layout and updating the Revision Block in the new Design Construction Sheet File Paper Space Layout; and, routing conformed As-Built drawings, comprising the new Demolition Construction Sheet File Paper Space Layout and new Design Construction Sheet File Paper Space Layout, for approval to apply the changes to the latest historical Record Drawing File (2D, 3D model or Digital Twin file). Check for design conflicts and resolve. (Design methods 7a and 7b can be used during the As-built Drawing Conformance process, if necessary).

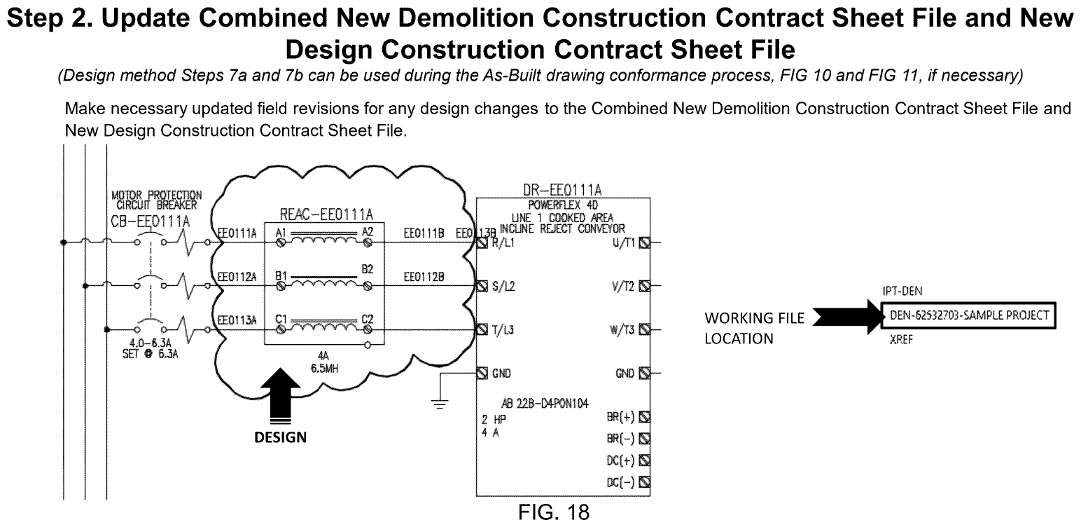

FIG. 18 shows a detailed screenshot view of performing a Step 2—Update (conform) the Combined new Demolition Construction File and new Design Construction Sheet File. Make necessary revisions to the Combined new Demolition Construction File and new Design Construction Sheet File if necessary for any field revisions that occurred during construction activities. (Design methods 7a and 7b can be used during the As-built Drawing Conformance process, if necessary).

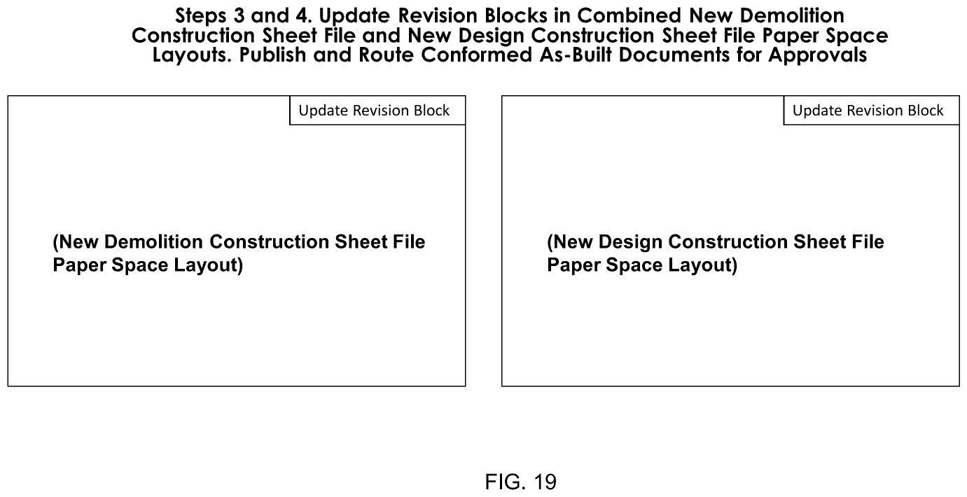

FIG. 19 shows a detailed screenshot view of performing Steps 3 and 4—Update Revision Blocks in the Combined new Demolition Construction File and new Design Construction Sheet File. Update Revision Block in the new Demolition Contract Sheet File Paper Space Layout and the new Design Construction Sheet File Paper Space Layout. Publish both Paper Space Layouts and route the Conformed As-Built Documents for Approval. Upon approval, continue to the O&M Record Drawing Conformance Process.

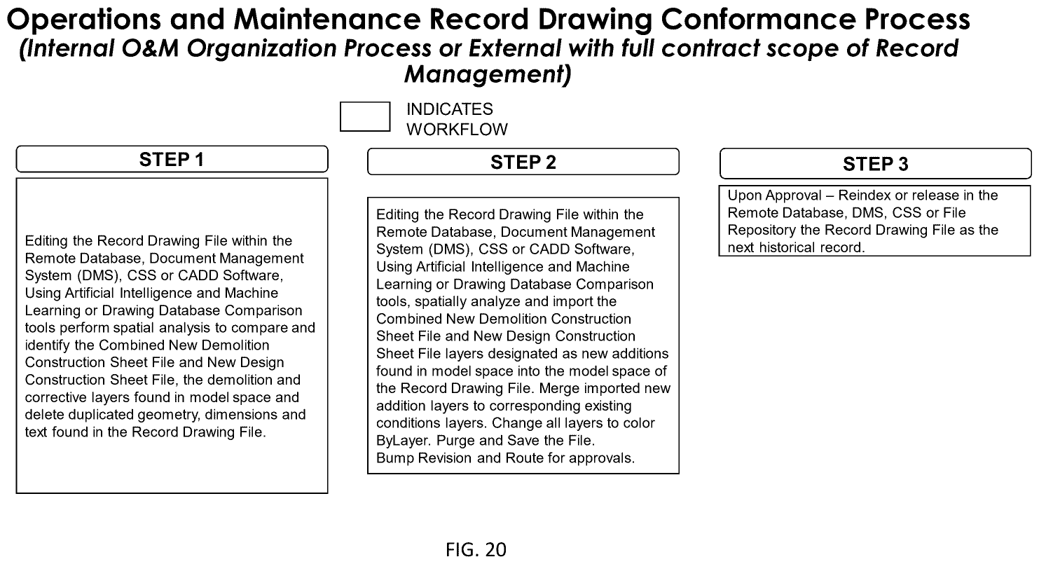

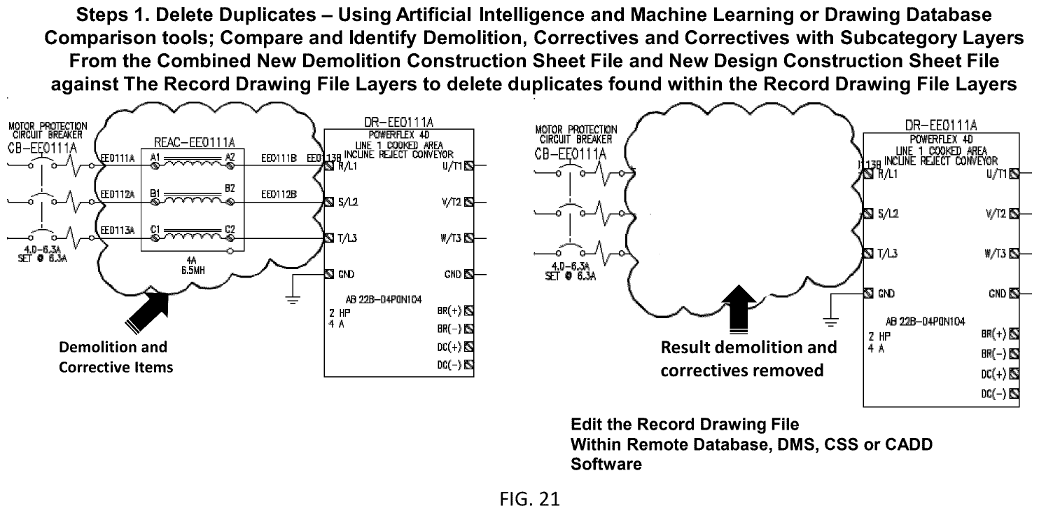

FIG. 20 is a flowchart showing an exemplary O&M Record Drawing Conformance Process for protecting the integrity of dynamically modified files for Assets, in an aspect. Exemplary actions taken are described in more detail with respect to FIGS. 21-23, below.

FIG. 21 shows a detailed screenshot view of performing a Step 1—Editing the Record Drawing File (2D, 3D model or Digital Twin file) within a Remote Database, Document Management System, Cloud Computing Service, CADD software or File Repository, download to the working location.

Step 1—Using Artificial Intelligence and Machine Learning or Database Comparison Tools to perform spatial analysis to compare, identify and perform a deletion of duplicated geometry, dimensions and text to remove from the Record Drawing File (2D, 3D model or Digital Twin file) objects that are duplicated on the Layer or Layers designated for Demolition, Correctives and Correctives with subcategory found within the Combined new Demolition Construction File and new Design Construction Sheet File.

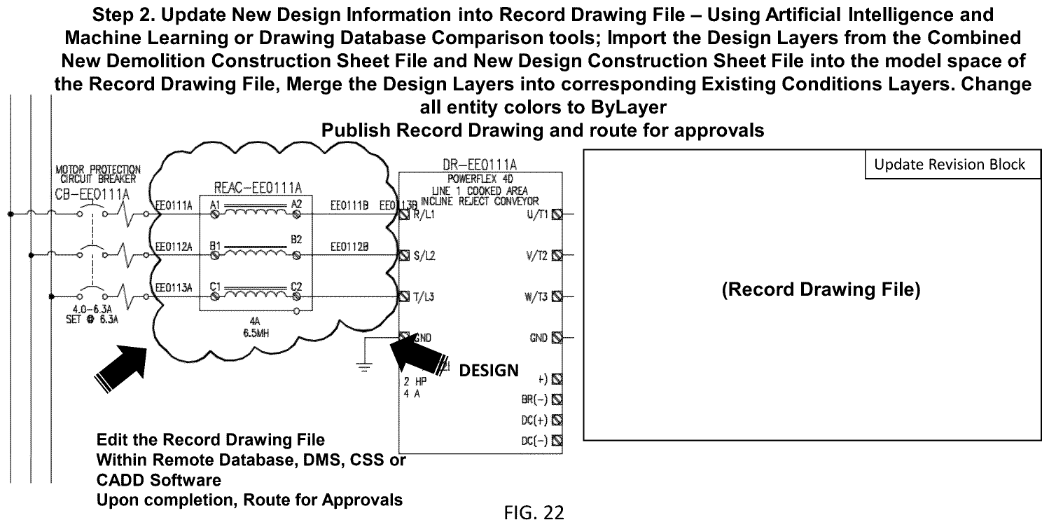

FIG. 22 shows a detailed screenshot view of performing Step 2 as outlined below.

Using Artificial Intelligence and Machine Learning or Database Comparison Tools to perform spatial analysis by querying all the Layer or Layers designated for Design found in the Combined new Demolition Construction File and new Design Construction Sheet File model space into the model space of the Record Drawing File (2D, 3D model or Digital Twin file) merge Design Layers into corresponding existing condition layers and adjust all entity colors to ByLayer.

Update revision block +1 revision—RECORD Description per O&M CADD Standards. PURGE and SAVE the file. Publish Record Drawing and route for final approvals.

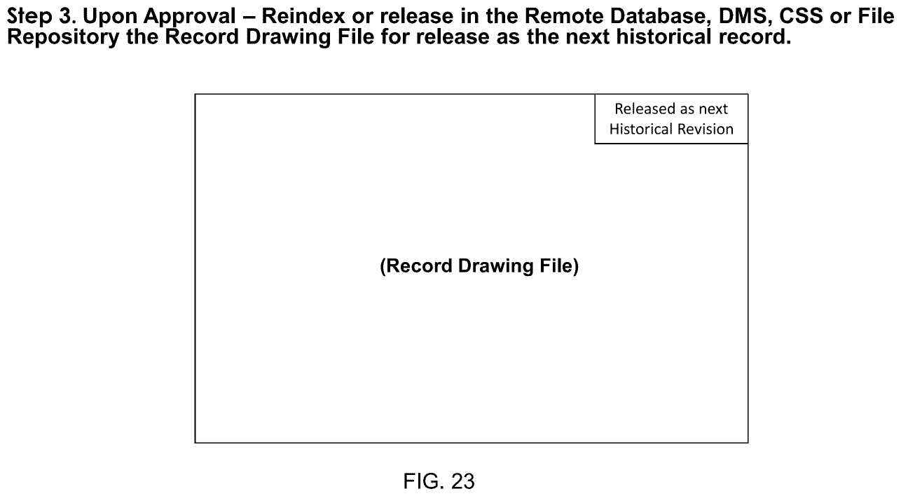

FIG. 23 shows a detailed screenshot view of performing a Step 3 as outlined below.

Upon approval—Reindex or release in the Remote Database, DMS, CCS, or File Repository the Record Drawing File (2D, 3D model or Digital Twin file) for release as the next historical record.

The terms “comprises”, “comprising”, “includes”, “including”, “having” and their conjugates mean “including but not limited to”.

The term “consisting of” means “including and limited to”.

The term “consisting essentially of” means that the composition, method or structure may include additional ingredients, steps and/or parts, but only if the additional ingredients, steps and/or parts do not materially alter the basic and novel characteristics of the claimed composition, method or structure.

As used herein, the singular form “a”, “an” and “the” include plural references unless the context clearly dictates otherwise. For example, the term “a compound” or “at least one compound” may include a plurality of compounds, including mixtures thereof.

Throughout this application, various embodiments of this invention may be presented in a range format. It should be understood that the description in range format is merely for convenience and brevity and should not be construed as an inflexible limitation on the scope of the invention. Accordingly, the description of a range should be considered to have specifically disclosed all the possible subranges as well as individual numerical values within that range. For example, description of a range such as from 1 to 6 should be considered to have specifically disclosed subranges such as from 1 to 3, from 1 to 4, from 1 to 5, from 2 to 4, from 2 to 6, from 3 to 6 etc., as well as individual numbers within that range, for example, 1, 2, 3, 4, 5, and 6. This applies regardless of the breadth of the range. Further, described ranges are intended to include numbers outside any range described within statistical error and/or inherent measurement equipment limitations.

Whenever a numerical range is indicated herein, it is meant to include any cited numeral (fractional or integral) within the indicated range. The phrases “ranging/ranges between” a first indicate number and a second indicate number and “ranging/ranges from” a first indicate number “to” a second indicate number are used herein interchangeably and are meant to include the first and second indicated numbers and all the fractional and integral numerals therebetween.

It is appreciated that certain features of the invention, which are, for clarity, described in the context of separate embodiments, may also be provided in combination in a single embodiment. Conversely, various features of the invention, which are, for brevity, described in the context of a single embodiment, may also be provided separately or in any suitable subcombination or as suitable in any other described embodiment of the invention. Certain features described in the context of various embodiments are not to be considered essential features of those embodiments, unless the embodiment is inoperative without those elements.

Although the invention has been described in conjunction with specific embodiments thereof, it is evident that many alternatives, modifications, and variations will be apparent to those skilled in the art. Accordingly, it is intended to embrace all such alternatives, modifications and variations that fall within the spirit and broad scope of the appended claims.

All publications, patents and patent applications mentioned in this specification are herein incorporated in their entirety by reference into the specification, to the same extent as if each individual publication, patent or patent application was specifically and individually indicated to be incorporated herein by reference. In addition, citation or identification of any reference in this application shall not be construed as an admission that such reference is available as prior art to the present invention. To the extent that section headings are used, they should not be construed as necessarily limiting.

What is claimed is:

1. An operations and maintenance enhanced design drawing conformance process for Assets for protecting the integrity of dynamically modified files, comprising:
downloading or copying a Record Drawing File (2D, 3D model or Digital Twin file) from a Remote Database, Document Management System (DMS), Cloud Computing Service (CCS), or File Repository;
conforming the Record Drawing File (2D, 3D model or Digital Twin file) for CADD standards for proper model space and paper space usage;
reindexing the conformed Record Drawing File (updated 2D, 3D model or Digital Twin file) into the Remote Database, DMS, CCS, or File Repository;
renaming the conformed downloaded or copied Record Drawing File (updated 2D, 3D model or Digital Twin file) matching the Record Drawing File Name and with a Unique Project Identifier suffix to distinguish that this document is for project purposes, known as the Combined new Demolition Construction File and new Design Construction Sheet File, which allows a user to discern that removal and addition edits to an existing Record Drawing File (2D, 3D model or Digital Twin file) is required and which also prevents overwrite of data by concurrent changes occurring to the same Record Drawing File;
creating Layer or Layers designated for Demolition that includes demolition objects to be removed in the Combined new Demolition Construction File and new Design Construction Sheet File;
creating Layer or Layers designated for Correctives with an additional layer or layers created with a subcategory definition for existing conditions that do not exist in the field that includes existing conditions that require drawing correctives for content or location in the Combined new Demolition Construction File and new Design Construction Sheet File;
changing demolition objects to the corresponding Demolition Layer or Layers within the Combined new Demolition Construction File and new Design Construction Sheet File;
freezing the Layer or Layers designated for Correctives with Subcategory definition within the new Demolition Sheet File Paper Space Layout Viewport(s) to remove them from visibility;
plotting the new Demolition Construction Sheet File Paper Space Layout and distributing it for construction activities to show items to be removed in the field during construction activities;
creating a new Design Construction Sheet File Paper Space Layout by copying the new Demolition Construction Sheet File Paper Space Layout and renaming the copied Paper Space Layout to represent the new Design Construction Sheet File Paper Space Layout to distinguish that this Paper Space Layout is the document for design purposes;
freezing the Layer or Layers designated for Demolition, Correctives and Correctives with Subcategory within the new Design Sheet File Paper Space Layout Viewport(s) to remove them from visibility; and,
plotting the new Design Construction Sheet File Paper Space Layout and distributing it for construction activities to show items to be added in the field during construction activities.

2. The process according to claim 1, wherein downloading is from a Remote Database, DMS, CCS, or File Repository.

3. The process according to claim 1, wherein conforming includes validating and applying Layer standards, validating Borders as externally referenced entities, inserting Border Informational Text into a Paper Space Layout to allow for variable information to be managed and maintained, allowing for mapped values (metadata) into the Remote Database, DMS, CCS, or File Repository, and moving historical text, dimensions and notes found in paper space into model space to their correct spatial locations and applying an appropriate scale factor to this information to ensure legibility and that all historical data can be correctly used within the process.

4. The process according to claim 1, wherein conforming includes re-indexing the conformed Record Drawing File (updated 2D, 3D model or Digital Twin file) into the Remote Database, DMS or CCS, or File Repository prior to the creation of the Combined new Demolition Construction Sheet File and new Design Construction Sheet File to ensure that all drawing historical data, now in model space, is saved, available and can be correctly used within the process.

5. The process according to claim 1, wherein renaming matching the Record Drawing File Name and with a Unique Project Identifier suffix to distinguish that this document is for project purposes, known as the Combined new Demolition Construction Sheet File and new Design Construction Sheet File which allows a user to discern that removal and addition edits to an existing Record Drawing File (2D, 3D model or Digital Twin file) is required, while also preventing overwrite of data by concurrent changes occurring to other copies of the same Record Drawing File (2D, 3D model or Digital Twin file) by other files with another Unique Project Identifier Number suffix.

6. The process according to claim 5, further comprising saving the Combined new Demolition Construction Sheet File and new Design Construction Sheet File in a separate directory designated for Project Files used for file compositions in the Combined new Demolition Construction Sheet File and new Design Construction Sheet File.

7. The process according to claim 1, further comprising making sure that the origins of both the Record Drawing File (2D, 3D model or Digital Twin file) and the Combined new Demolition Construction Sheet File and new Design Construction Sheet File are in the same location spatially.

8. The process according to claim 1, wherein creating the new Design Construction Sheet File Paper Space Layout further comprises freezing the Layer or Layers designated for Demolition, Correctives and Correctives with Subcategory within the new Design Construction Sheet File Paper Space Layout Viewport(s). Save the file.

9. The process according to claim 1, wherein creating the Combined new Demolition Construction Sheet File and new Design Construction Sheet File further comprises placing all new items to be added during the construction project on the appropriate discipline specific Layer or Layers designated for Design, wherein all layer names used in the Record Drawing File (2D, 3D model or Digital Twin file), Combined new Demolition Construction Sheet File and new Design Construction Sheet File should be exactly the same in naming convention with a designation to categorize Demolition, Correctives, Correctives with subcategory and Design with the entity properties set to ByLayer.

10. The process according to claim 1, further comprising creating a Layer or Layers designated for Correctives with additional layers created as needed for a subcategory that designates Corrective items that do not exist in the field in the Combined new Demolition Construction Sheet File and new Design Construction Sheet File.

11. The process according to claim 10, further comprising correcting items in the new Combined new Demolition Construction Sheet File and new Design Construction Sheet File in model space, changing the layers they reside on to a corresponding Layer or Layers designated for Design and forcing the color to grayscale within the Combined new Demolition Construction Sheet File and new Design Construction Sheet File, placing these objects in the desired location, then changing the copied source objects to the Layer or Layers designated for Correctives within the Combined new Demolition Construction Sheet File and new Design Construction Sheet File, and grayscaling all existing condition layers in the Combined new Demolition Construction Sheet File and new Design Construction Sheet File.

12. The process according to claim 11, further comprising deleting items in the Combined new Demolition Construction Sheet File and new Design Construction Sheet File.

13. The process according to claim 1, wherein creating the new Demolition Construction Sheet File Paper Space Layout includes freezing within the Paper Space Layout Viewport(s) the Layer or Layers designated for Design and the Layer or Layers designated for Correctives with Subcategory if it is being used to remove an existing condition that does not exist in the field and placing notes and call out leaders on the appropriate layers in paper space.

14. The process according to claim 1, wherein creating the new Design Construction Sheet File Paper Space Layout includes freezing the Layer or Layers designated for Demolition and Correctives (including subcategory layers) in the new Design Construction Sheet File Paper Space Layout Viewport(s).

15. The process according to claim 1, wherein creating the new Design Construction Sheet File Paper Space layout includes copying the new Demolition Construction Sheet File Paper Space Layout and renaming it to represent the new Design Construction Sheet File and placing notes and call out leaders on the appropriate layers in paper space, as these notes relate to construction activities only and will not be retained as historical information for incorporation into the Record Drawing File (2D, 3D model or Digital Twin file).

16. The process according to claim 1, wherein colors are used to differentiate at least one of the layers, files, and operations to be performed.

17. The process according to claim 1, further comprising:
prior to publication for release of the new Demolition Construction Sheet File Paper Space Layout and the new Design Construction Sheet File Paper Space Layout For Construction Activities, perform the following steps within the Combined new Demolition Construction Sheet File and new Design Construction Sheet File to ensure all information found within the Record Drawing File (2D, 3D model or Digital Twin file) is maintained as the current version within the Combined new Demolition Construction Sheet File and new Design Construction Sheet File;
updating all Revision Blocks in the Paper Space of the Combined new Demolition Construction Sheet File and new Design Construction Sheet File for release. downloading or copying a Record Drawing File (2D, 3D model or Digital Twin file) from Remote Database, DMS, CCS, or File Repository to a working location;
deleting all layers in model space of the Combined new Demolition Construction Sheet File and new Design Construction Sheet File with exception of the Layer or Layers designated for Demolition, Correctives, Correctives with subcategory and Design and with the use of Artificial Intelligence and Machine Learning or Database Comparison Tools to perform spatial analysis of the Record Drawing File (2D, 3D model or Digital Twin file) to import all layers found in model space into the Combined new Demolition Construction Sheet File and new Design Construction Sheet File;
using Artificial Intelligence and Machine Learning or Database Comparison Tools to spatially locate and validate duplicated items that will be deleted, comparing between the imported content of the Record Drawing File and the Layer or Layers designated for Demolition, Correctives and Correctives with subcategory of the Combined new Demolition Construction Sheet File and new Design Construction Sheet File, then removing these duplicated items that were imported from the Record Drawing File within the Combined new Demolition Construction Sheet File and new Design Construction Sheet File while retaining all objects found on the Layer or Layers designated for Demolition, Correctives, Correctives with subcategory and Design within the Combined new Demolition Construction Sheet File and new Design Construction Sheet File;
checking and resolving any design conflicts;
saving the file; and,
routing for approvals and releasing for construction activities.

18. The process according to claim 1, further comprising:
conforming the Combined new Demolition Construction Sheet File and new Design Construction Sheet File for As-built including making revisions to the file in both model space and paper space for any field revisions that occurred during construction activities;
downloading or copying a Record Drawing File (2D, 3D model or Digital Twin file) from a Remote Database, DMS, CCS, or File Repository to a working location; deleting all layers in model space of the Combined new Demolition Construction Sheet File and new Design Construction Sheet File with exception of the Layer or Layers designated for Demolition, Correctives, Correctives with subcategory and Design and performing spatial analysis of the Record Drawing File (2D, 3D model or Digital Twin file) with the use of Artificial Intelligence and Machine Learning or Database Comparison Tools to import all layers found in the model space of the Record Drawing File into the model space of the Combined new Demolition Construction Sheet File and new Design Construction Sheet File;
using Artificial Intelligence and Machine Learning or Database Comparison Tools to spatially locate and validate duplicated items that will be deleted, comparing between the imported content of the Record Drawing File and the Layer or Layers designated for Demolition, Correctives and Correctives with subcategory of the Combined new Demolition Construction Sheet File and new Design Construction Sheet File, then removing these duplicated items that were imported from the Record Drawing File within the Combined new Demolition Construction Sheet File and new Design Construction Sheet File while retaining all objects found on the Layer or Layers designated for Demolition, Correctives, Correctives with subcategory and Design within the new Demolition Construction Sheet File;
conforming the Combined new Demolition Construction Sheet File and new Design Construction Sheet File for As-built including making revisions to the Combined new Demolition Construction Sheet File and new Design Construction Sheet File in both model space and paper space, if necessary, for any field revisions that occurred during construction activities;
updating the Revision Block in the new Demolition Construction Sheet File Paper Space and updating the Revision Block in the new Design Construction Sheet File Paper Space;
checking and resolving any design conflicts;
saving the file; and,
routing the conformed As-Built drawings, comprising the new Demolition Construction Sheet File Paper Space and new Design Construction Sheet File Paper Space, for approval to apply the changes to the latest historical Record Drawing File (2D, 3D model or Digital Twin file).

19. The process according to claim 1, further comprising:
downloading or copying a Record Drawing File (2D, 3D model or Digital Twin file) from a Remote Database, DMS, CCS, CADD Software, or File Repository to a working location;
using Artificial Intelligence and Machine Learning or Database Comparison Tools to perform spatial analysis to compare, identify and perform a deletion of duplicated geometry, dimensions and text to remove from the existing conditions of the Record Drawing File (2D, 3D model or Digital Twin file) objects that are duplicated on the Layer or Layers designated for Demolition, Correctives and Correctives with subcategory found within the Combined new Demolition Construction Sheet File and new Design Construction Sheet File;
confirming Record objects have been successfully deleted then delete the imported Layer or Layers designated for Demolition, Correctives and Correctives with subcategory;
using Artificial Intelligence and Machine Learning or Database Comparison Tools to perform spatial analysis to query the Combined new Demolition Construction Sheet File and new Design Construction Sheet File and import all new Layer or Layers designated for Design found in model space into the Record Drawing File (2D, 3D model or Digital Twin file) merge the imported Design Layers into the corresponding existing condition layers and adjust all entity colors to ByLayer; and,
plotting Record Drawing File (2D, 3D model or Digital Twin file) and routing the plotted Record Drawing File (2D, 3D model or Digital Twin file) for approval prior to indexing the Record Drawing File (2D, 3D model or Digital Twin file) into the Remote Database, DMS, CCS, CADD Software, or File Repository as the next released historical record.
